(19) United States
(12) Patent Application Publication
(10) Pub. No.: US 2019/0261620 A1
(43) Pub. Date: Aug. 29, 2019

(54) Novel Pest Barricade

(71) Applicant: John Koshar, Tucson, AZ (US)

(72) Inventor: John Koshar, Tucson, AZ (US)

(21) Appl. No.: 15/908,658

(22) Filed: Feb. 28, 2018

(51) Int. Cl. A01M 29/30; E06B 7/28

(52) U.S. Cl. CPC A01M 29/30; E06B 7/28

(57) ABSTRACT

A novel barricade used to seal the gap between a door, weather stripping and a door frame. The barricade successfully prevents pests or rodents from breaching the barricade and entering into the garage or other area. The barricade uses a spring assist with low displacement force in order to conform to the changing downward or upward angle when a garage door is being operated. It also includes magnetized rubber seals to prevent chaffing to the garage door surface. This barrier stays in-place and is unable to be pulled off of the garage door face by pests or rodents and remains effective for long durations.

### BACKGROUND

While many barricades exist, there is still a need for barricades that can completely seal the space between the door corner and the door frame. None of the barricades currently available prevent the pests or rodents from entering into the garage through the cavity formed at the bottom and side parts of the doorframe and door corners. The main problem with existing barricades is that rodents persistently bite and gnaw the unprotected vertical weather stripping at the bottom of the door causing the seals to fail. Further, other existing barriers, when installed in a door, do not cover the full width of the garage door. The remaining unprotected area, the garage door corners, is where the rodents enter into the garage's interior.

Automatic garage doors have two mechanisms to prevent injuries being caused when the door is in the closing mode of operation. One being where an object, crossing the threshold travel path, provides an optical signal that stops the door from completely closing or crushing the object. The other being, that a door in the closing mode of operation would stop and then retreat to the fully open position if the door assembly senses approximately eleven pounds of resistance. These mechanisms are triggered when a sensor detects an optical or physical obstruction. These mechanisms prevent crushing damage to automobiles and household items and prevents injuries to people and pets. However, none of the existing barricades have an anti-crushing, anti-lift or over-rotation mechanism for protection.

Protuberant objects attached to automatic doors can cause injuries when an external object is close enough to be hooked by the protuberant object. This is a well-known fact at industrial worksite settings. For example, if a person is standing close enough to the door, the person's clothes or similar material can be hooked by the protuberant objects attached to the door while it is closing or opening. When the door is moving, clothes or similar material can be ripped or damaged or the individual can be lifted or injured. None of the existing barricades prevent external objects from hooking or hanging from the door.

Embodiments of the present invention solve these problems in a very unique manner and effectively prevent rodents from entering into a garage or similar area. It is inexpensive to produce, easily installed by the homeowner, and requires no maintenance other than painting.

### SUMMARY

The present invention relates to barricades and, more particularly, barricades located on the bottom corner of the door. The embodiments of the present invention result in pest barricades that are safe for people of all ages, pet-safe, poison-free, and cruelty-to-animal free. They are simple and durable devices that are relatively inexpensive to produce, easily installed by the homeowner, their employed handyman, or home builder. They require no maintenance other than painting. The embodiments of the present invention deter pest intrusion through the open space into the garage interior.

### BRIEF DESCRIPTION OF THE DRAWINGS

The embodiments of the present invention will be better understood from a reading of the following description taken in conjunction with the drawings in which like reference designators are used to designate like elements, and in which:

FIG. 1A illustrates a top view of the door and the door frame;

FIG. 1B illustrates a front view of the door and door frame;

FIG. 2A shows a top view of an embodiment of the barrier completely sealing the space between the door and door frame when the door is fully closed;

FIG. 2B illustrates a plan view of an embodiment of the barrier, showing the interaction between the T-shape extrusion and the stop member with the housing and the spring;

FIG. 2C shows a top plan view of an embodiment of the barrier in the on position when the door is fully closed, completely sealing the space between the door and door frame;

FIG. 2D illustrates a plan view of an embodiment of the barrier in the off position when the door is open or in a closing transition; showing the movement of the T-shape extrusion;

FIG. 3A shows a partial perspective plan view of the embodiment of the barrier of FIG. 2C in the on position;

FIG. 3B shows a partial perspective plan view of the embodiment of the barrier of FIG. 2D in the off position;

FIG. 3C shows a side view of an example of the barrier of FIG. 2C in the on position, showing the position of three springs;

FIG. 3D shows a side view of the example barrier of FIG. 2D in the off position, showing the position of three springs;

FIG. 4A illustrates a top plan view of the door, which shows the relative proximity of a door frame and weather stripping;

FIG. 4B illustrates a top plan view of FIG. 4A and a barricade according to an embodiment of the invention;

FIG. 5A shows a front view of an alternate embodiment of the barrier when the door is fully closed;

FIG. 5B shows a front view of the alternate embodiment of the barrier when the door is partially open;

FIG. 6A shows a front view of FIG. 5B and the relative positioning of the barrier as the door opens;

FIG. 6B shows a front view of FIG. 5B and the relative positioning of the barrier as the door closes;

### DESCRIPTION

The foregoing embodiments are to be considered for illustrative purposes and as an exemplification of the principles of the invention and are not intended to limit the broad aspects of the invention to the specific embodiments illustrated herein. The features, structures, or characteristics of the invention as disclosed in any one preferred embodiment, for example, may be rearranged or combined with the features, structures or characteristics in any other embodiment. One skilled in the relevant art will also recognize that the invention may be practiced without one or more of the specific details, or with other methods, components, materials, and so forth. In other instances, well-known structures, materials, or operations are not shown or described in detail to avoid obscuring aspects of the invention.

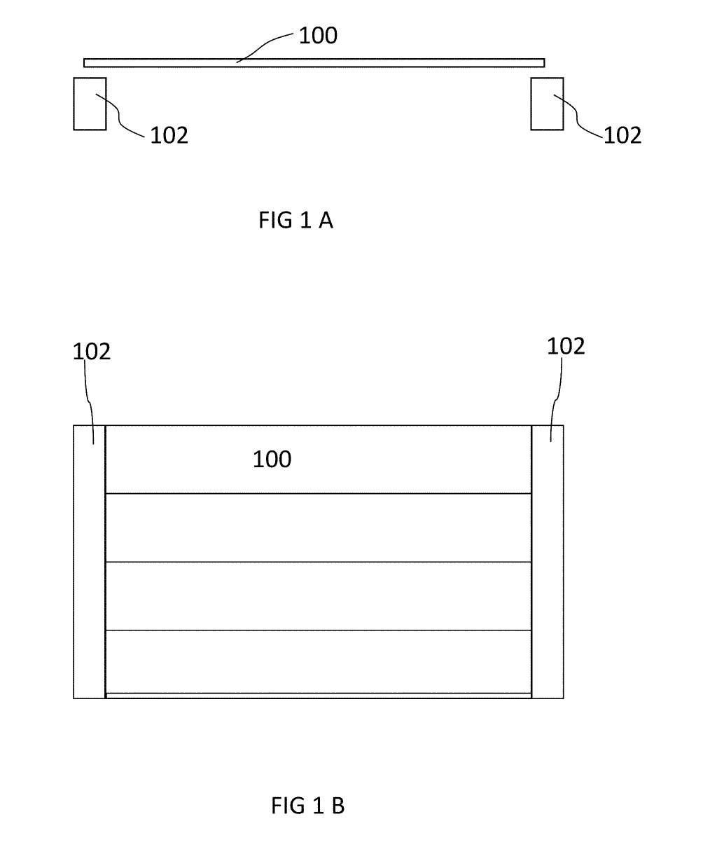

FIGS. 1A and 1B are an example of a garage door 100 and a door frame 102 that are used in common households.

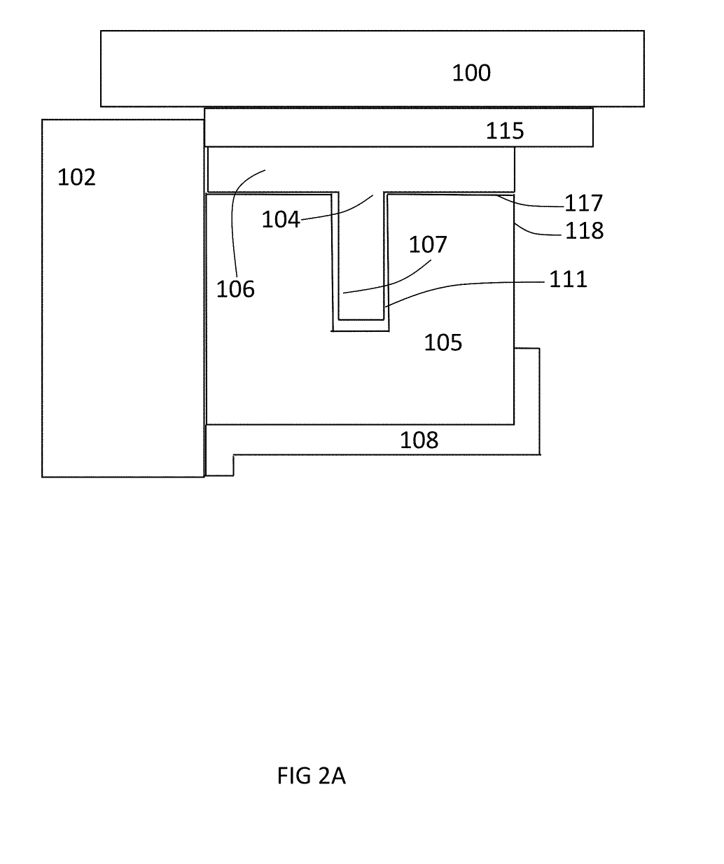

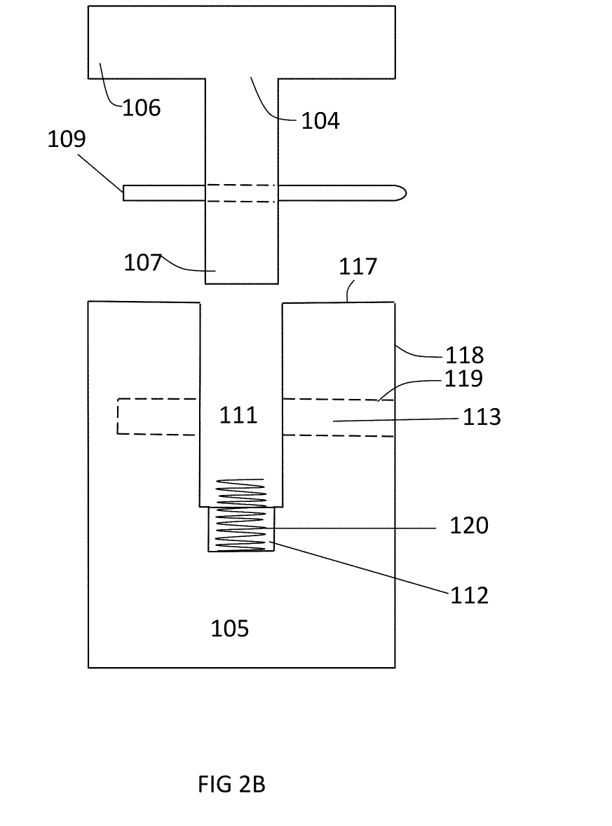

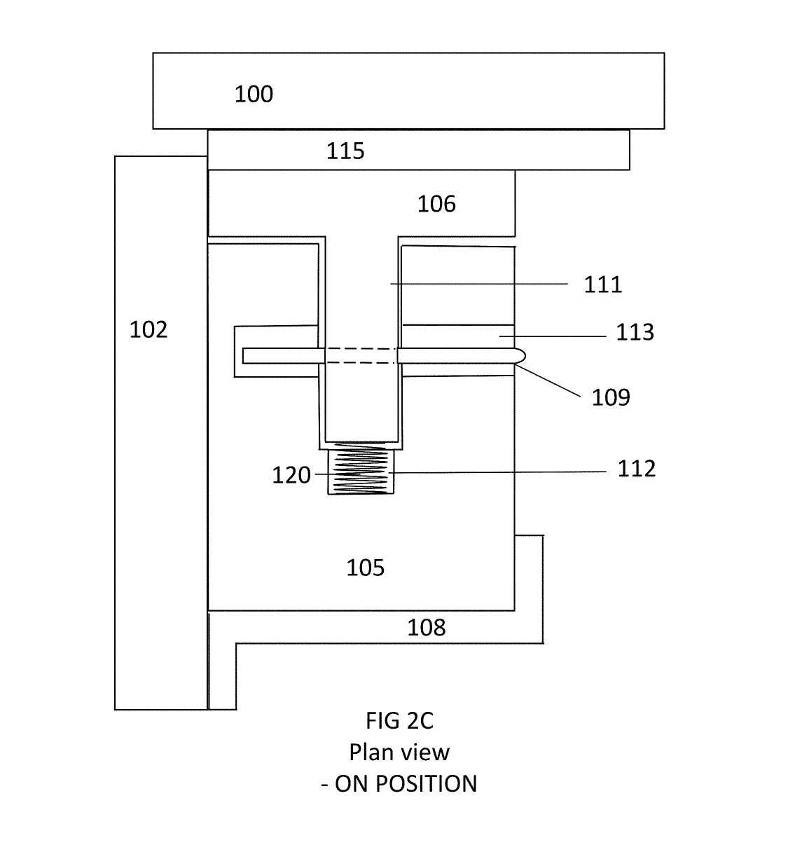

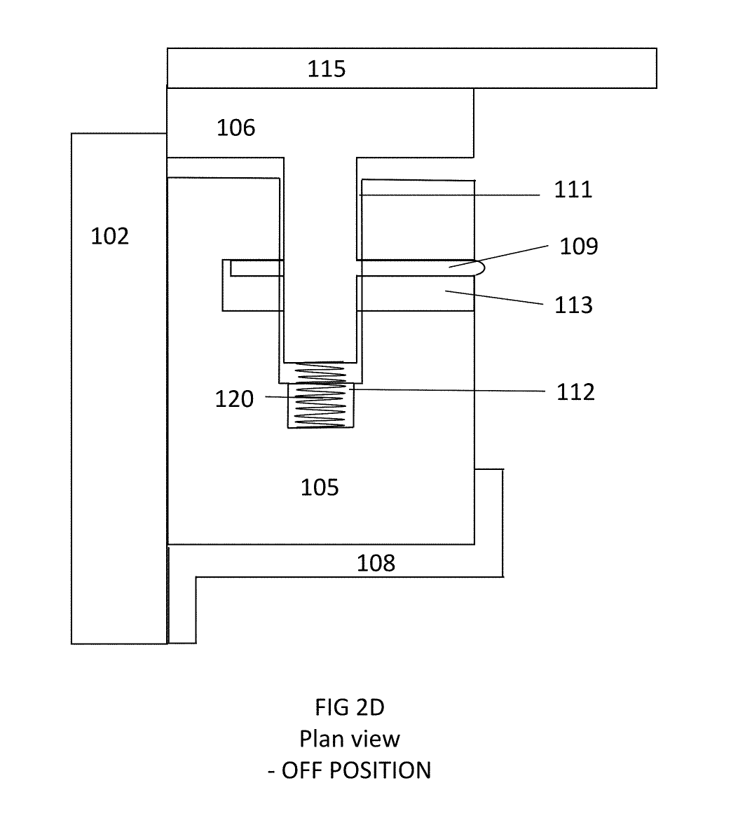

FIG. 2A is an example of the proposed barricade and its housing. It includes: a housing 105 which is affixed to the door frame 102. The housing 105 partially encloses a T-shape extrusion 104 that provides the various components that will provide the barrier enclosure. Attached to the T-shape extrusion 104 is a magnetic rubber seal 115 that provides a stronger force from the door frame, against the garage door. A Z-fixing member 108 also slidably couples the housing 105 to the door frame 102. The housing 105 has a first side 117 and a second side 118. The T-shape extrusion 104 inserts into the first cavity 111 located on the first side 117 of the housing 105. The magnetic rubber seal 115 is attached to the first member of the T-shape extrusion 106. The magnetized face of the magnetic rubber seal 115 is facing the door 100.

In FIG. 2B, the T-shape extrusion 104 is formed by a first member 106 and a second member 107. The housing 105 also has a first cavity 111, a second cavity 112, and a third cavity 113. The first cavity 111 is on first side 117. The second cavity 112 is connected to the first cavity 111. The third cavity 113 is located on the second side 118. A stop member 109 fully crosses the second member 107 of the T-shape extrusion 104. The second member 107 of the T-shape extrusion 104 inserts into the first cavity 111. The stop member 109 crossing the second member 107 of the T-shape extrusion 104 inserts into the third cavity 113 of the housing 105. A spring 120 is disposed between the second cavity 112 and first cavity 111 of the housing 105.

In FIG. 2C, the door 100 is fully closed and the space between the door 100 and the doorframe 102 is completely sealed. The barrier is in an on position as the spring 120 is compressed. The spring 120 pushes the bottom part of both the T-shape extrusion 104 and the magnetic rubber seal 115 against door 100. The stop member 109 rests in the third cavity 113. The housing 105 and the Z-fixing member 108 remain in a static position and affixed to the doorframe 102.

In FIG. 2D, door 100 is in an open or partially open position. The barrier is in an off position because the spring 120 is distended. Spring 120 at the bottom part of both the T-shape extrusion 104 and the magnetic rubber seal 115 are distal from the housing 105. Stop member 109 stops the T-shape extrusion 104 from going further by resting at the edge of the third cavity 113. Housing 105 and Z-fixing member 108 remain static and affixed to the doorframe 102.

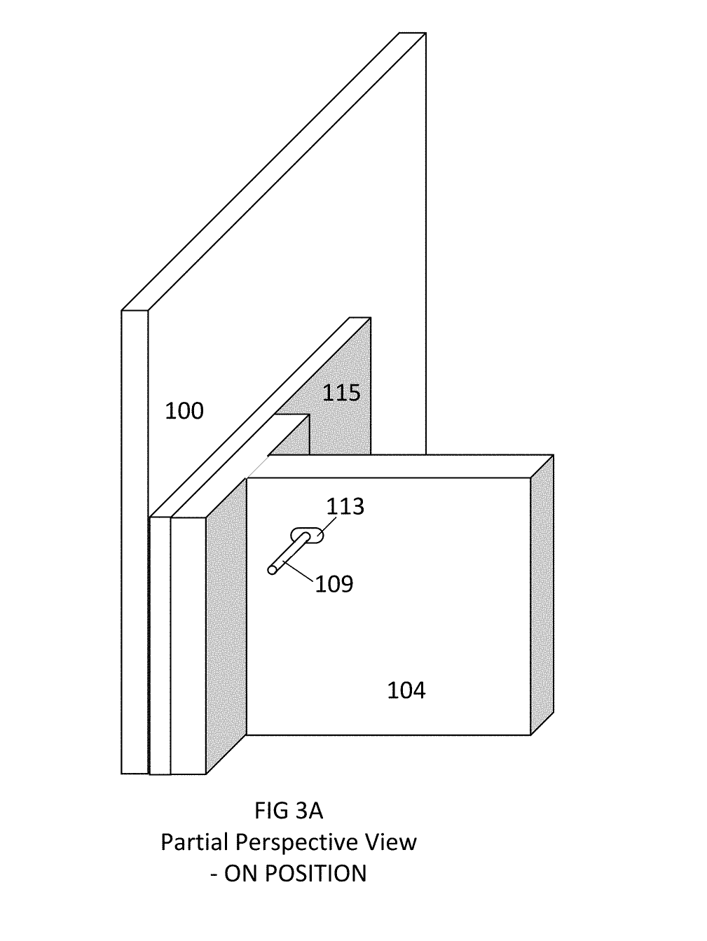

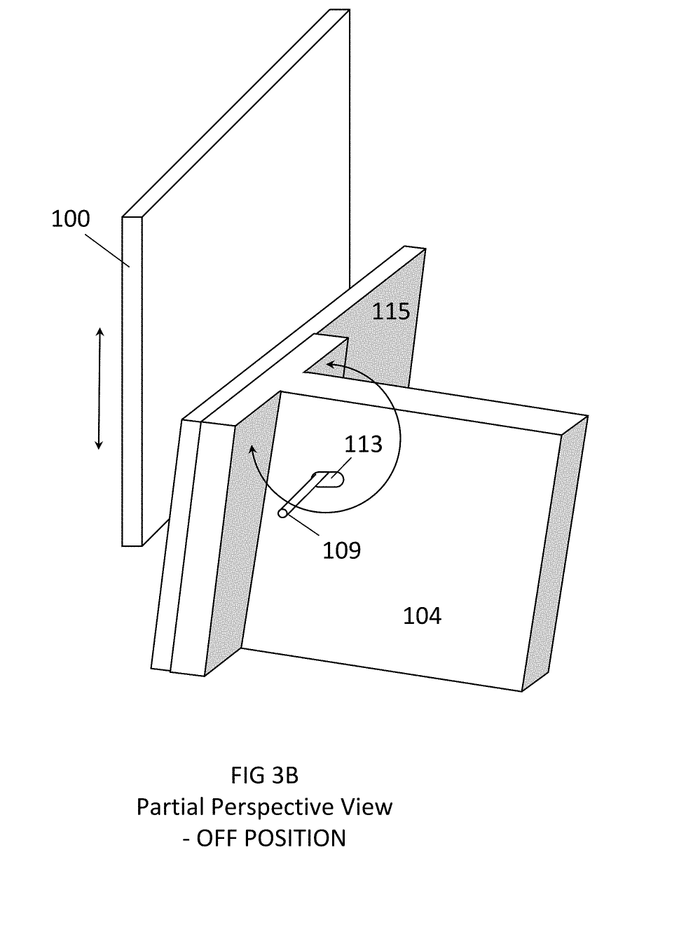

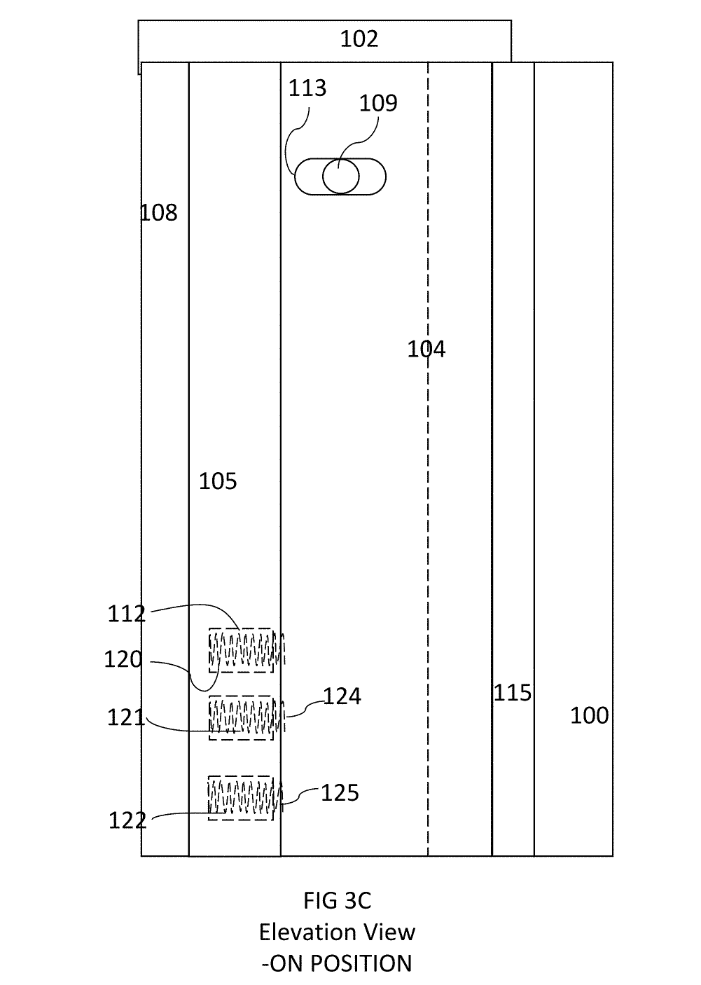

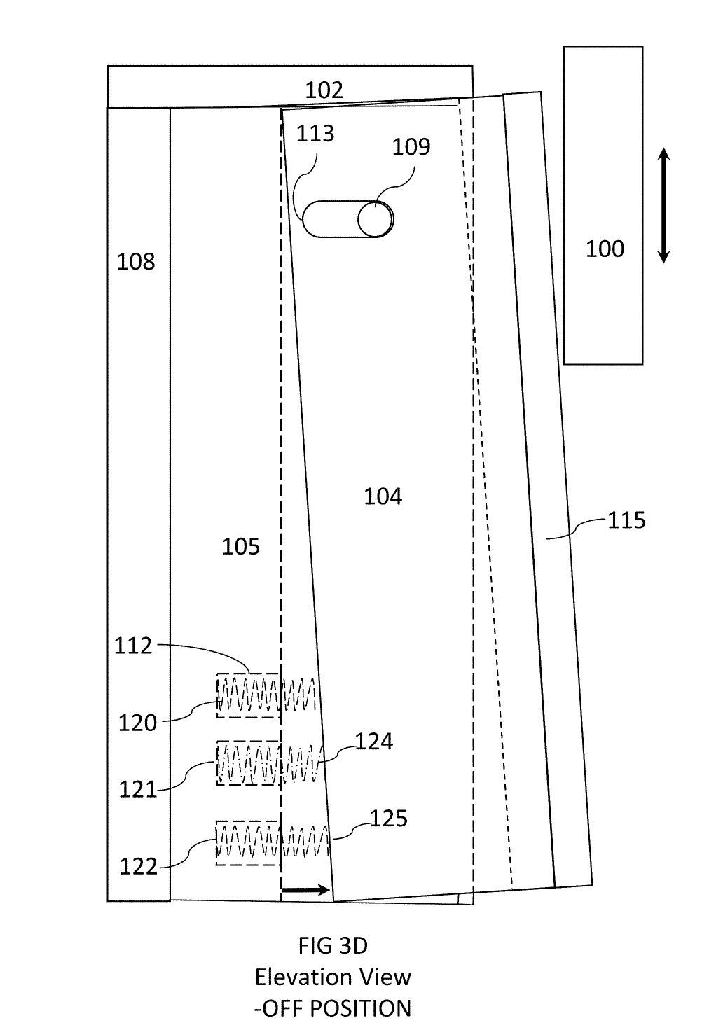

In FIG. 3A, housing 105, Z-fixing member 108, and spring 120 are not shown. The barrier is in the on position. The space between the door 100 and the doorframe 102 is sealed. Spring 120 (not shown) pushes the bottom part of both the T-shape extrusion 104 and the magnetic rubber seal 115 against door 100. The stop member 109 rests in the third cavity 113.

In FIG. 3B, housing 105, Z-fixing member 108, and spring 120 are not shown. The barrier is in the off position and door 100 is partially open. Spring 120 pushes the bottom part of both the T-shape extrusion 104 and the magnetic rubber seal 115 distal from the housing 105. The stop member 109 stops the T-shape extrusion 104 from going further by resting at the edge of the third cavity 113.

FIGS. 3C and 3D show an alternative embodiment of the barricade using three springs and therefore, compressing more forcefully the T-shape extrusion 104 and the magnetic rubber seal 115 against the door 100. Housing 105 has a fourth cavity 124 and a fifth cavity 125. The first spring 120 is disposed in the second cavity 112. The second spring 121 is disposed in the fourth cavity 124. The third spring 122 is disposed in the fifth cavity 125.

In FIG. 3C the barrier is in the on position. Springs 120, 124, and 125 push the bottom part of the both the T-shape extrusion 104 and the magnetic rubber seal 115 against the door 100. The stop member 109 rests in the third cavity 113. The housing 105 and Z-fixing member 108 remain static and affixed to the door frame 102.

In FIG. 3D the barrier is in the off position. The springs 120, 124, 125 are extended and pushing the bottom part of both the T-shape extrusion 104 and the magnetic rubber seal 115 against the door 100. Stop member 109 stops the T-shape extrusion 104 from going further by resting at the edge of the third cavity 113.

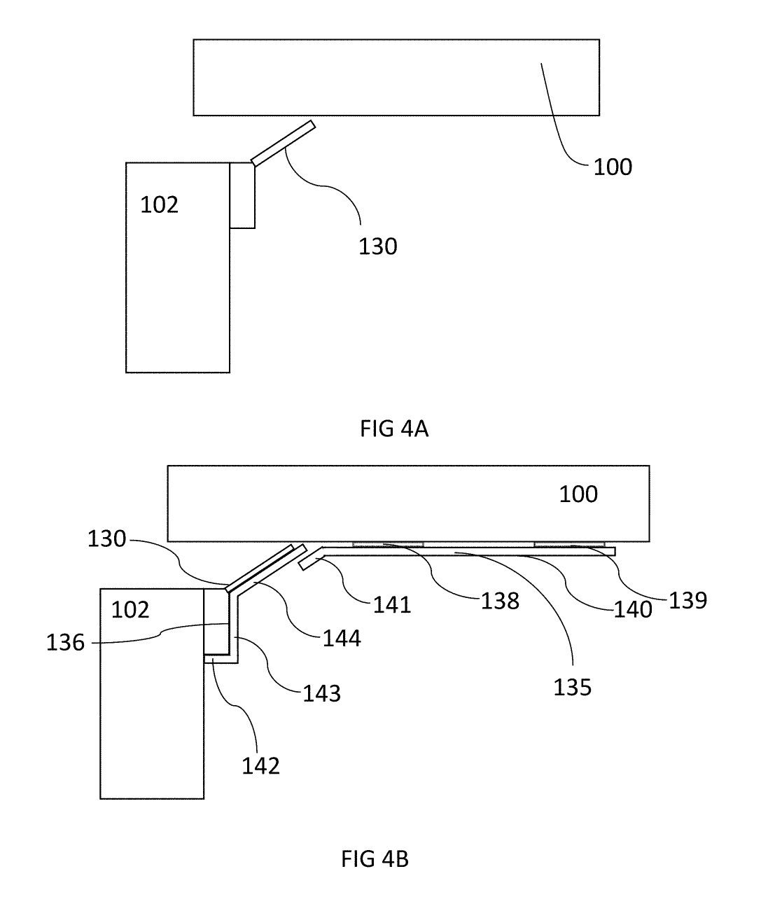

In FIG. 4A, a weather stripping 130 is affixed to the door frame 102.

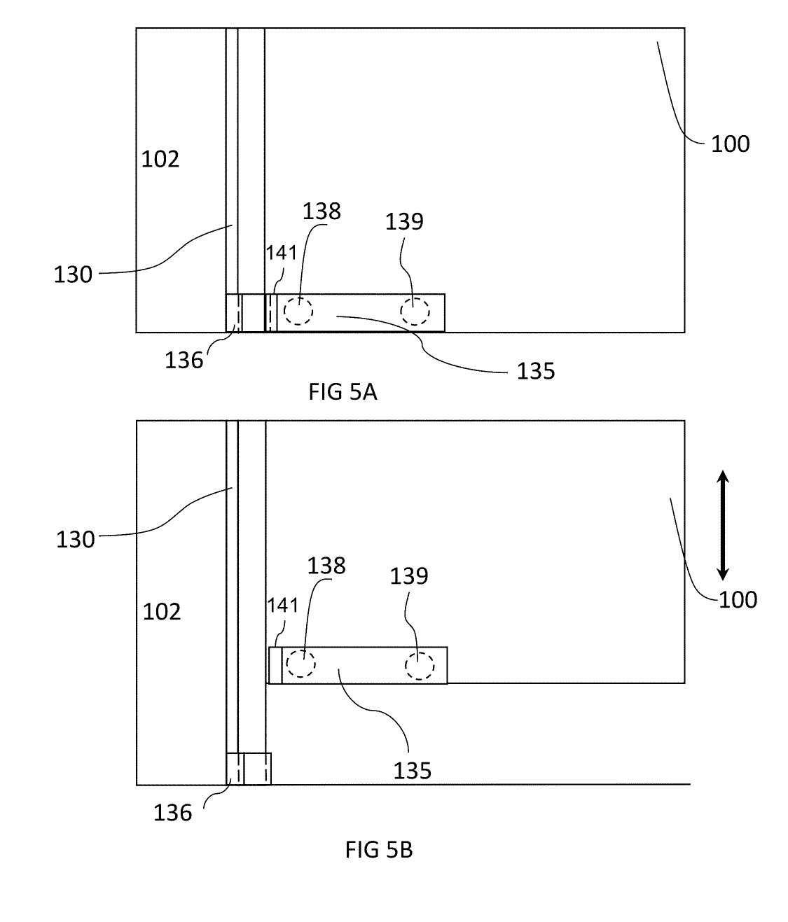

FIGS. 4B, 5A and 5B, are another embodiment example of the barrier. In FIG. 5A the door 100 is in the closed position, whereas in FIG. 5B the door 100 is in the open position. A first barrier plate 135 has a first portion 140 and a second portion 141. The first portion 140 attaches to the door 100 via the magnetic force of a first magnet 138 and second magnet 139. The magnets 138 and 139 may comprise rubber or a rubber-like substance to avoid chafing door 100. Magnets 138 and 139 are placed on the first portion 140; preferably on separate sides of the first portion 140. The second portion is an angled outward feature from the door 100. A second barrier plate 136 has a third portion 142, fourth portion 143, and fifth portion 144. The third portion 142 covers the outward face of the weather stripping 130. The fourth portion 143 covers the face of the weather stripping 130. The fifth portion 144 at an angle parallel to and past the edge covers the flexible seal flap of the weather stripping 130.

FIG. 5A further shows the second barrier plate 136 and first barrier plate 135 with the second portion 141, with magnets 138 and 139, shown in-place, and the second portion 141 edge is up-to and near the edge of the flexible seal flap of weather stripping 130. An additional first barrier plate 135, with two magnets 138, less a second portion 141, is shown in-place and may be added in plurality across the lower face of the door 100 using a mirrored installation of a first barrier plate 135, with two magnets 138 and 139, including second portion 141 up to the opposite garage door frame 102 with attached weather seal stripping 130;

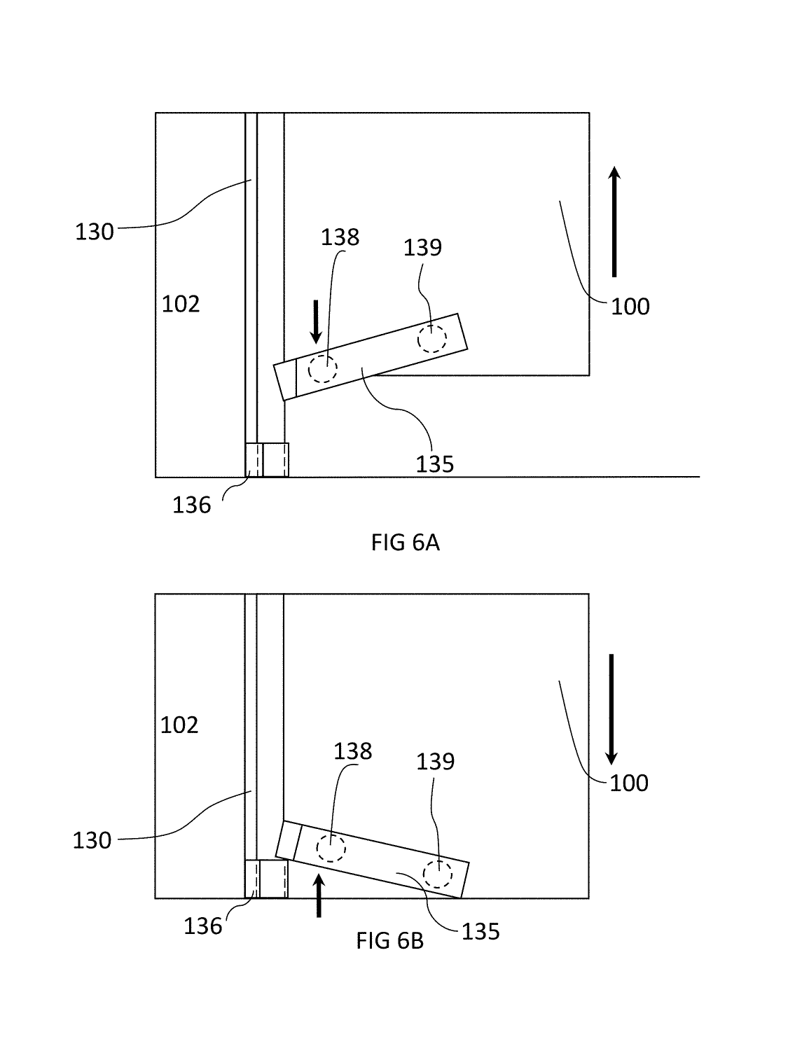

In FIGS. 6A and 6B, the second barrier plate 136 remains still when the door opens. The first barrier plate 135 is affixed to and moves with door 100. The magnet 138 alternatively detaches from the door 100 while magnet 139 stays attached to the door 100.

FIG. 6A shows door 100 in the opening transition position relative to the door frame 102. The first magnet 138 detaches from the door 100. The second magnet 139 keeps the first barrier plate 135 attached to the door 100.

FIG. 6B shows the door in the closed position. The second magnet 139 detaches from the door 100. The first magnet 138 keeps the first barrier plate 135 attached to the door 100.

While the preferred embodiments of the present invention have been illustrated in detail, it should be apparent that modifications and adaptations to those embodiments may occur to one skilled in the art without departing from the scope of the present invention.

What is claimed:

1. An apparatus for obstructing a bottom-corner space formed between a door and a door frame, comprising:
a T-Shaped extrusion having a first member and second member;
a magnetized barrier plate attached to said first member of the T-Shaped extrusion having its magnetized surface towards the door;
a stop member attached to said second member of the T-Shaped extrusion;
at least one spring, which holds the T-shaped Extrusion against the door;
a housing having:
a first side,
a second side perpendicular to said first side;
a first cavity on the first side having a first length,
a second cavity connected to the first cavity having a second length wherein the first length of the first cavity is longer than the second length of the second cavity, and
a third cavity on said second side having a third side;
wherein:
said second member of the T-Shaped extrusion is inserted in the first cavity;
said spring is disposed in said second cavity;
said stop member is disposed within the third cavity; and
said second member of the T-Shaped extrusion outwardly slides from said first cavity when the spring expands until the stop member reaches said third side of the third cavity.

2. The apparatus of claim 1, further comprising, a second spring, and a third spring;
the housing further comprising a fourth cavity and a fifth cavity,
wherein:
the first cavity is longer than the second cavity;
said second spring is disposed in said forth cavity; and
said third spring is disposed in said fifth cavity such that the T-shaped extrusion is slidably coupled to the door.

3. An apparatus for obstructing a bottom-corner space formed between a door and a door frame and bottom spaces formed between a door and uneven threshold surfaces comprising:
a first barrier plate comprising a first portion and second portion, wherein the first portion is magnetically coupled to a bottom portion of a garage door;
a second barrier plate comprising a third, fourth, and fifth portion, wherein the third portion is coupled to a fourth portion and the fourth portion is attached to the fifth portion and wherein the fourth portion is attached to a door frame; and
The second and fifth portion create a line in parallel to create a barrier.

4. The apparatus of claim 3, wherein the magnetic barrier plate is magnetically coupled to the door at each end of the barrier plate such that either end may detach from the door while the opposite side remains connected to the door.
